(19) United States
(12) Patent Application Publication
(10) Pub. No.: US 2022/0058706 A1
(43) Pub. Date: Feb. 24, 2022

(54) System and Method with Cryptography for Verifying Consent to a Property Transaction

(71) Applicant: SeniorSafe USA LLC, Washington, DC (US)

(72) Inventors: Roger Norris Gordon, Washington, DC (US); John Mark Johnston, McLean, VA (US)

(73) Assignee: SeniorSafe USA LLC, Washington, DC (US)

(21) Appl. No.: 17/494,691

(22) Filed: Oct. 5, 2021

Related U.S. Application Data
(63) Continuation-in-part of application No. 16/430,406, filed on Jun. 3, 2019, now abandoned.
(60) Provisional application No. 62/679,313, filed on Jun. 1, 2018.

(51) Int. Cl. G06Q 30/06; G06F 21/10; H04L 9/32; H04L 9/30

(52) U.S. Cl. CPC G06Q 30/0611; G06F 21/10; H04L 9/30; H04L 9/3236; H04L 9/3247

(57) ABSTRACT

A system and method, in various embodiments, maintains a cryptographically protected ledger of transactions pertaining to enabling a property owner to require subsequent holders of interests in its property to verify the property owner's informed consent to any transaction that creates or created an interest in its property in any other party. The method may include receiving, at a computing device running an automated agent, a request from a property owner to prepare a record of a contract for verifying and authenticating title-modifying transactions according to a protective scheme included in the contract and a covenant recorded against the title of the real property, which are stored as digital records in a cryptographically protected ledger. A digital certificate is used to verify authenticity of the digital records and confirm consent to the title-modifying transaction.

### CROSS-REFERENCE TO RELATED APPLICATIONS

This application is a Continuation-In-Part of U.S. patent application Ser. No. 16/430,406, filed Jun. 3, 2019, now pending, which claims benefit to U.S. Provisional Patent Application No. 62/679,313, filed Jun. 1, 2018, all of which are hereby incorporated by reference.

### BACKGROUND OF THE INVENTION

### Field of Invention

The present disclosure relates generally to a computerized system and method for verifying consent to a property transfer using cryptography.

### Description of the Prior Art

Financial exploitation of the elderly is a growing problem. Fraud targeting seniors' homes is particularly acute. They can lose their homes or home equity to bad actors if they sign contracts for sale, mortgage agreements, gift deeds, or other title-related contracts that are fraudulent or while they are under undue influence or experiencing diminished financial capacity. Collectively, these dangers are referred to herein as “Harm.” Numerous public agencies, consumer groups, and trade associations warn the problem will grow worse in the coming decades as America ages because many people experience failing eyesight, hearing, memory, and cognition as they grow older. Younger people also can experience physical and emotional hardships that make it harder for them to make good financial decisions.

The Securities and Exchange Commission advises seniors to consider sharing the details of their financial affairs with a trusted friend or relative who can raise a red flag if they suspect something is amiss. Unfortunately, many property owners do not know anyone who can take on this responsibility. However, even if they do know such a person, a friend or relative typically does not have the expertise, authority or legal standing (except for a spouse) and needs more to mount a challenge, especially if the bad actor is a relative or the victim's attorney. More fundamentally, many people do not want to share the details of their financial affairs with friends or relatives, even ones they trust.

A law professor has suggested that senior citizens could record covenants onto their homes' titles—so-called Elder HELP Instruments—expressly repudiating repugnant loan terms or excessive rates and fees. Even if it was possible to record a comprehensive list of predatory terms and keep it current, a question would remain as to whether a subsequently recorded agreement would be construed as superseding it. Also, the covenant could be revoked at the behest of a bad actor through undue influence or fraudulent inducement of the homeowner. A bad actor who obtained an interest in the property through any of these means could then sell its interest to a third party. This third party would be able to enforce its interest unless the defrauded homeowner could prove it acquired its interest in bad faith. Finally, there would be no way to remove the cloud on the title of a property protected by such an Elder HELP Instrument. Every subsequent interest holder, e.g., a purchaser or mortgagee, would have to determine whether its interest or any prior interest from which its interest was derived either violated or complied with the terms of the Elder HELP Instrument and its prohibition against “repugnant” or “excessive” terms, rates, and fees. Even if the subsequent interest holder believed it was in compliance, it would still be exposed to claims by the homeowner or its estate or heirs. Such exposure could negatively impact the marketability of subsequent interests in the property and likely also reduce its current value.

Until now, the most effective way property owners could protect themselves against Harm was to put their properties into irrevocable trusts managed by trustees. A trust is created when legal title to property is held by one person for the benefit of another. Although this is not the method of the present invention, the trust approach has several benefits, each of which the present invention shares, and several problems, each of which the present invention overcomes.

The first benefit of using an irrevocable trust managed by a third party is that the beneficiary of a trust is not completely isolated. This is because beneficiaries must interact with trustees. This reduces the effect of isolation and its role in enabling Harm. Second, when there is a competent third-party trustee, due diligence occurs regardless of the beneficiary's sophistication or mental state. Third, because the trustee appears on the title, the trustee is able to learn of and respond to fraudulent transactions directly and early on. In a legal challenge in which the authenticity of a signature or the knowledge and intent of the victim are at question, a trustee would likely enjoy greater credibility and be able to provide more persuasive evidence to a court than a private individual could, particularly one who was incapacitated or deceased.

The main problem with irrevocable trusts is that they require the homeowner to relinquish legal title to their property. If a property owner puts their property into a trust and then wants to sell, gift, or mortgage it, they must seek the trustee's permission. Many property owners are reluctant to put themselves in this position.

Another problem is expense. A senior who does not have a friend, relative, or acquaintance who is capable, willing, and trustworthy enough to be their trustee must hire a professional. Tax planning, compliance, audit, legal, and other overhead also add costs. Another cost driver is the requirement that a trustee always be available to conduct due diligence, authenticate transactions, defend the title, and respond to any future incapacity as well as to the eventual death of the beneficiary.

Finally, because a trustee holds legal title to a property and is only accountable to the beneficiary, any malfeasance or misfeasance on the trustee's part would be hard to detect if the beneficiary were to experience a decline in capacity, become isolated, or die. When the trustee is a lawyer, attorney-client privilege compounds the danger by shielding malfeasance from discovery.

Today, when defrauded property owners contest title transactions they usually allege fraud in the inducement, incapacity, duress, undue influence, unilateral mistake, unconscionability, forgery, or fraud in the execution. These claims can be difficult and expensive to prove, especially when the victim's memory, hearing, vision, judgment, awareness, or independence are at question or when the victim no longer has capacity or has died. More critically, only the last two claims—forgery and fraud in the execution—are grounds for rescinding fraudulent agreements after they have been sold by bad actors to third parties.

Forgery, i.e., creating a false document or signature, and fraud in the execution, i.e., hiding the true nature of an agreement, such as by secretly switching papers at the signing, are relatively rare and easier to prove than the other claims listed above. A stranger cannot steal a person's home simply by forging a signature on a deed and a bank cannot force a homeowner to repay a mortgage someone else obtained through fraud. Furthermore, unlike with other types of fraud, even if the perpetrators of forgery or fraud in the execution are successful, they cannot pass along good title to subsequent buyers. This is why many attorneys believe that services that are offered to protect homeowners against “title theft” by monitoring their titles in exchange for a monthly fee are not worth the money.

A much more common and far more successful species of fraud is “fraud in the inducement,” i.e., providing false or misleading information to a party to persuade them to sign an agreement. For example, a bad actor might tell a senior homeowner, falsely, that signing the house over to them is the only way to prevent the IRS from foreclosing on it. The senior knowingly signs over their home but only because they believe the falsehood that the IRS will otherwise take away their home. Not only is fraud in the inducement difficult to prove but, as discussed below, obtaining a remedy is often impossible.

Under the bona fide purchaser doctrine, a third party who purchases a property from a bad actor who obtained it from a victim through fraudulent means other than forgery or fraud in the execution is immune to a recovery action by the victim if the third party acquired its interest in good faith, i.e., without knowledge of the underlying fraud or of any other party's claim against the property. The bona fide purchaser can take good title to the property despite the claims of the defrauded original owner who may bring an action only against the party that transferred the property to the bona fide purchaser.

Under the holder in due course rule defined in the Uniform Commercial Code Section 3-302, a purchaser of a promissory note, mortgage, or other negotiable instrument may collect upon it over the objections of a defrauded obligor if the purchaser—the holder in due course—purchased the instrument in good faith and without notice that it had been dishonored or contained an unauthorized signature or had been altered or that any party had a defense or claim in recoupment. As in the case of a homeowner who is swindled by a bad actor who sells its property to a bona fide purchaser, a homeowner defrauded by a lender who sells the note to a holder in due course can only seek remedy against the bad actor. They must still pay the holder in due course.

Thus, although fraudulent inducement can be grounds for rescinding a contract, if the property or promissory note has been sold to a third party, to recover the property or prevent the enforcement of the note, the victim must prove that it was defrauded by the bad actor and that the third party knew or should have known about the underlying fraud. Because this is a very high hurdle to clear, in practice, a defrauded homeowner often can only seek damages from the person who defrauded them.

In this way, the bona fide purchaser doctrine and holder in due course rule allow bad actors to effectively launder ill-gotten titles and mortgages by selling them to third parties and then disappearing with the proceeds.

When a homeowner places its property into an irrevocable trust managed by a third party, fraud in the inducement is less likely to succeed because the trustee's due diligence is likely to detect it. Not only is a trust company more likely to have the resources to contest fraud in court but it also is likely to enjoy certain indicia of credibility, e.g., professional business practices and reputation, and to have a presence in the marketplace that would make it difficult for a fraudster to succeed. However, these features also increase the cost of trustee services and put them beyond the reach of most people.

To address these disadvantages, the present invention uses a legal covenant to “freeze” a home's title in a manner similar to freezing one' s credit to prevent interests in the home from being created in third parties. The present invention employs a cryptographic technique to prevent the title from being unfrozen by anyone other than an enforcement agent charged with protecting the homeowner from Harm.

The present invention protects homeowners against Harm by solving at least three problems better than existing solutions do: (1) It provides homeowners with a trustworthy and affordable party who can maintain vigilance over their ability to make property-related decisions and to protect them if they become vulnerable or are victimized; (2) It prevents subsequent purchasers of any fraudulently obtained interests in their properties from raising bona fide purchaser or holder in due course defenses to their recovery efforts. (3) It allows legitimate future title holders to prove, from only the documents in the records, without contacting prior owners, that their title was obtained without Harm and that the requirements of the protective covenant were followed. The invention leverages technology to keep costs low and provide trustee-like services at an affordable price.

Although some embodiments present the case for combining cryptographic techniques with recorded covenants and notices to protect owners of real property, the method of the present invention may be applied to protect any property that exists in a jurisdiction or regime in which property ownership and interests are determined by reference to an authoritative record or ledger of property interests and transactions.

### SUMMARY OF THE INVENTION

The present invention may satisfy one or more of the above-mentioned desirable aspects. Other features and/or aspects may become apparent from the description which follows. The systems, methods and devices of the disclosure each have innovative aspects, no single one of which is indispensable or solely responsible for the desirable attributes disclosed herein. Without limiting the scope of the claims, some of the advantageous features will now be summarized.

In one aspect there is provided a computer-implemented method for maintaining a blockchain distributed ledger of transactions pertaining to the transfer of a property protected by the enforcement agent. The method includes: receiving, at a computing device, a request from a property owner to prepare a contract record for storing contract data regarding terms of the contract, wherein terms and conditions of the contract includes a protective scheme; such contracts are added to the blockchain by the enforcement agent either manually or by an automated process; contracts may include covenant records for recording covenant data regarding recordation of a covenants against the titles of the properties based on contracts, wherein each property covenant includes a public key and a protective covenant; creating a digital signature by signing the protective covenant with a cryptographic signature private key of the enforcement agent; future transaction activity related to property must then be also received and recorded to the blockchain; this will enable the enforcement agent to verify and authenticate a property transfer-related events according to terms of the contract's protective scheme stored earlier in the blockchain.

In another aspect, a non-transitory computer readable storage medium at a computing device running an enforcement agent and having connectivity to a network, wherein the non-transitory computer readable storage media are encoded with instructions that, when executed by a processor, cause the processor to perform a method for maintaining a blockchain distributed ledger of transactions pertaining to verifying consent of a transfer of a particular property. The method includes: receiving, at a computing device running an enforcement agent, a request from a property owner to prepare a contract record for storing contract data regarding terms of the contract in a blockchain; dynamic monitoring, by the enforcement agent of transaction activity related to a real property owned by the property owner to verify and authenticate a title-related event according to terms of the contract, wherein terms and conditions of the contract includes a protective scheme; generating, by the enforcement agent, a covenant record for recording covenant data regarding recordation of a covenant against the title of the real property based on the contract, wherein the covenant includes a public key and a protective covenant; creating a digital signature by signing the protective covenant with a cryptographic signature private key of the enforcement agent; and storing, by the enforcement agent, the data of the contract record and the covenant record in a repository in a blockchain distributed ledger having a plurality of transactions stored in the blockchain formed from blocks of records containing transactions.

In the following description, certain aspects and embodiments will become evident. It should be understood that the invention, in its broadest sense, could be practiced without having one or more features of these aspects and embodiments. It should also be understood that these aspects are merely exemplary and explanatory and are not restrictive of the invention.

### BRIEF DESCRIPTION OF THE DRAWINGS

FIGS. 1A-1B illustrate an exemplary computer-implemented method for verifying consent of a property transaction using cryptography.

FIG. 2 illustrates a computing system for verifying consent of a property transaction using cryptography in accordance with aspects of the present teachings.

The skilled artisan will understand that the drawings described below are for illustrative purposes only. The drawings are not intended to limit the scope of the present teachings in any way.

### DETAILED DESCRIPTION OF THE EMBODIMENT(S)

The present disclosure provides enhanced layers of security for confirmation of a validated transfer with informed consent to a property transaction. Certain aspects of the present disclosure relate to a computerized system and method for authenticating property transactions using cryptographically secured digital certificates. Some aspects of the present disclosure relate to verifying a property owner's informed consent to a property transaction based on a blockchain ledger and process for recording and verifying ownership of the digital certificates associated with the property transaction.

The systems and methods allow one or more processors to receive from a user, such as a property owner, a request for creating an electronic protective scheme that establishes certain conditions and procedures that future title-related agreements must comply with before they may become enforceable. The systems and methods then allows the user to enter into a contract with an enforcement agent to enforce the protective scheme. In some embodiments, the user and the enforcement agent may sign the contract using an electronic agreement or a smart contract system.

According to various embodiments, one or more steps described herein may be implemented by a human user, a non-human user, or through the interaction of a combination thereof. For example, the systems and methods may allow a human operator to define the terms of the contract agreement. Other embodiments may automate one or more steps in the process, for example, another computer program, software application, artificial intelligence (AI) or a machine learning algorithm may automatically perform one or more steps described herein.

In various embodiments, the human operator using the computer or the computer, autonomously or upon request, may function as the enforcement agent. The systems and methods then enable the enforcement agent to provide instructions to the one or more processors to create cryptographically signed covenants and digital certificates that authenticate ownership, monitor future transactions of the property, prevent transfer of the title, and/or authorize transfer of the title, as governed by the cryptographically signed covenants and digital certificates. The systems and methods may prevent transfers of or modifications to the title (i.e., they may “freeze” the title). When a transaction satisfies the requirements of the protective scheme, the systems and methods may authorize the transfer or modification of the title (i.e., “unfreeze” the title). Once the protective scheme has been satisfied, future owners and interest holders of the property may depend upon the cryptographically signed certificates to provide enforceable interests.

The term “transfer,” as used herein, refers not only to a change of ownership of a property but also to the creation of any interest in a property in any party other than its current owner. The term “transfer” may also include, for example, a security interest in a property created in a mortgagee by a mortgage agreement and a future interest created in a beneficiary by a property owner's will. The term “transfer” is used for the sake of brevity and should not be interpreted as limiting the application of the disclosed invention.

In the following detailed description, numerous specific details are set forth to provide a full understanding of various aspects of the subject disclosure. It will be apparent, however, to one ordinarily skilled in the art that various aspects of the subject disclosure may be practiced without some of these specific details. In other instances, well-known structures and techniques have not been shown in detail to avoid unnecessarily obscuring the subject disclosure.

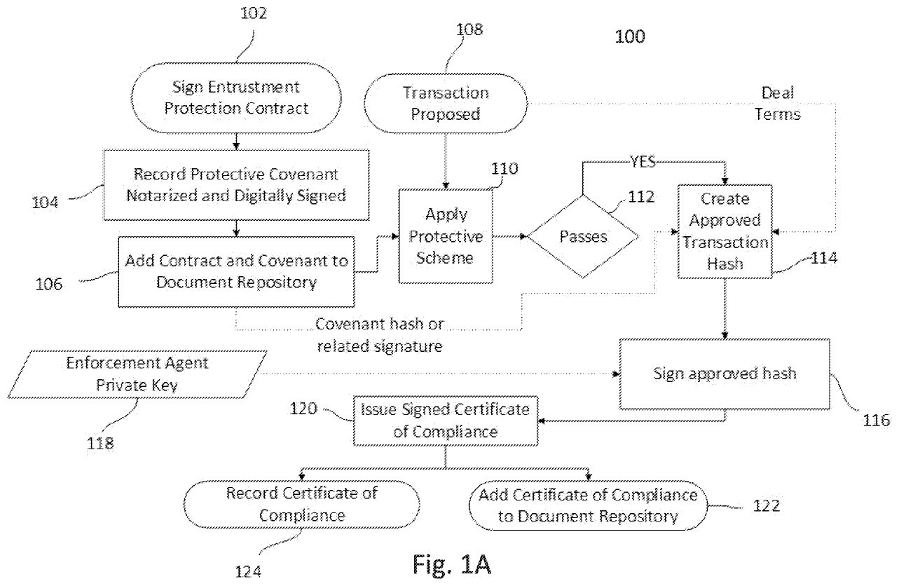

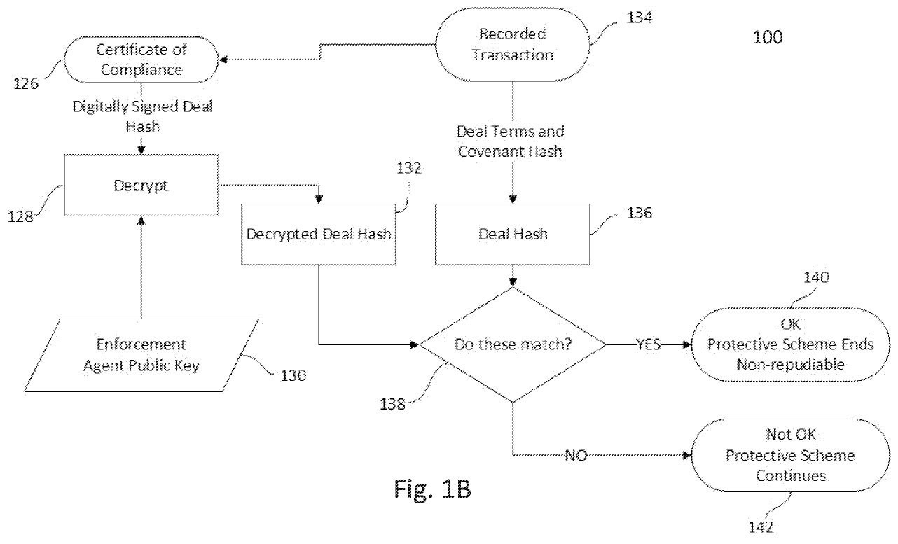

In one exemplary implementation, operation of the present invention may be consistent with the steps illustrated in the flowchart of FIGS. 1A-1B. It should, however, be understood that other alternative method steps may be employed and, even with the method depicted in FIGS. 1A-1B, the particular order of events may vary without departing from the scope of the present invention. Further, certain steps may not be present and additional steps may be added without departing from the scope and spirit of the invention as claimed.

FIGS. 1A-1B, as one example, illustrate a flow chart of a method 100 for generating digital certificates that are used to verify a property owner's informed consent to a property transaction. To implement the methods and systems, information, data, and/or programs can be stored in one or more databases. The method 100 allow one or more processors to receive from a user, such as a property owner, a request to create an electronic protective scheme that establishes certain conditions and procedures that future title-related agreements must comply with before they may become enforceable. In the description, the embodiments will be mainly described in terms of homeownership. However, it will be understood that other types of property ownership can be verified and monitored using the present invention. For example, the type of real property owned can be a residential, commercial, agricultural, industrial property, etc.

The protective scheme constraints entered into the computing system may define terms which should be met to effectuate transfer of the property. Namely, the protective scheme constraints protect against the unauthorized, deceptive or fraudulent transfer of the property. The protective scheme can require prospective buyers to enroll for verification. The protective scheme constraints may define terms that require prospective buyers, lenders, and giftees to provide identification information (including identifying the owners of any business entities they represent), to agree to background checks, and to make legally binding disclosures and affirmative representations upon enrollment into the computing system.

The method 100 may require the property owner to enter personal and relationship information that can be used to establish an alert or contact list. The property owner may designate friends, family members, legal representatives (i.e., an attorney, guardian, or trustee), or business contact in the alert-contact list. In some embodiments, the computing system may be programmed to autonomously conduct a search, such as on the Internet or an Intranet, to retrieve the personal and relationship information to build the user's alert-contact list.

Upon the request for a transfer of the property, the method may require that the computing system, using the alert-contact list, alert one or more designees listed in the contact list. The method may automatically alert, for example, the property owner's trusted friends, relatives and/or their financial advisor before the requested transfer or encumbrance is completed. The method may also require legal representation for the property owner under certain conditions. Legal representation may be required for the owner, for example, if the computing system or any person on the alert-contact list raises an issue of concern regarding the transaction. The method may also require the owner to be represented by legal counsel under certain other conditions, e.g., based on age, marital status (i.e., after the death of a spouse), or to conduct certain types of transactions, such as reverse mortgages.

The conditions defined in the protective scheme are designed to provide an automated process that prevents bad actors from fraudulently hiding behind business entities, prevents homeowners from entering into agreements while isolated, and to trigger and enforce due diligence regardless of the homeowner's state of mind or freedom to act. In this way, the present invention provides a function similar to that of a professional trustee but on an as-needed basis. The present invention provides an automated process that reduces cost and intrusiveness while providing robust protection against harmful property transfers.

In step 102 in FIG. 1A, the method 100 then allows the user, such as a homeowner, to enter into a contract with an enforcement agent to enforce the protective scheme that sets forth conditions precedent that future title transactions must meet. In some embodiments, the user and the enforcement agent may sign the contract using an electronic agreement or a smart contract system. Optionally, the method 100 may generate a smart contract that authenticates ownership of and/or tracks future transaction of the digital certificate. The method can store the smart contract in a smart contract database.

For instance, one such condition set forth in the contract may be that, by agreeing to the terms of the contract, the property owner acknowledges that no future agreement purporting to create an interest in the property in any third party will be valid unless the agreement bears a certificate of compliance signed by the enforcement agent. The method may automatically generate and issue an electronic certificate of compliance for the agreement. As part of its execution, the method produces an electronic certificate of compliance, which attests that the proffered agreement and the parties to it have complied with the terms of the protective scheme. This type of contract may be referred to as an entrustment protection contract and is enforceable by the party that provides the service even though it receives, rather than pays, consideration. The certificate of compliance may be stored by the system and method in a database, and the system may communicate the compliance, as needed.

As terms of the electronic contract, the system and method 100 automatically creates a property interest in the enforcement agent and records the property interest. The contract creates a property interest in the enforcement agent that may have, for example, the following three effects.

First, the method and system automatically establish the enforcement agent as a senior lienholder with respect to subsequent lienholders. A senior lienholder is a lienholder that has priority over another lienholder. If the property is or becomes subject to more than one lien, priority determines the lienholder's right. The method and system automatically records the property interest of the enforcement agent as a lien in the land records to provide a higher priority than later recorded liens. As a senior lienholder the enforcement agent is empowered to prevent future claims from being enforced if they are created through transactions that do not comply with the terms of the protective scheme the enforcement agent is contracted to enforce.

Second, the method and system may be programmed to stipulate the terms and circumstances under which the contract can or cannot be terminated. The terms of the contract may prevent the property owner from unilaterally terminating, revoking, or rescinding the contract. Mutual agreement between the property owner and the enforcement agent may be required to terminate, revoke or rescind the contract. This constraint prevents the property owner from dismantling the protective scheme if the property owner later becomes subject to undue influence or diminished financial capacity.

Third, the terms defined by the method and system give the enforcement agent standing to sue. Implementation of the method 100 provides standing to sue because the enforcement agent has a legally protectable and tangible interest in the property. Thus, the enforcement agent will be a proper party to fight any adverse action taken against the property. This gives the enforcement agent independent standing to pursue claims and remedies against bad actors. In comparison, the present invention is superior to a conventional trust approach because it allows a bad actor to be pursued by both the homeowner and the enforcement agent for independent claims. Trustees, on the other hand, can pursue claims only on behalf of the trust or, derivatively, on their own behalf as trustees of the trust.

In step 104 in FIG. 1A, the enforcement agent records and stores in a database a protective covenant against the title to the home and signs it with a private key. The covenant includes the enforcement agent's public key and states that any future certificates of compliance must be signed with the enforcement agent's private key.

The enforcement agent records its interest (sometimes referred to as a “negative easement”) in the form of a protective covenant against the title to the property. This recordation gives prospective interest holders constructive notice of the enforcement agent's presence as a senior lienholder, of the protective scheme, of the entrustment protection contract, and of the certification requirement. Once the protective covenant has been recorded, no interest can be created in any third party through a transaction agreement that is not accompanied by a certificate of compliance signed by the enforcement agent. In some embodiments, the enforcement agent is an automated agent that runs on a computing device. In other embodiments, the enforcement agent steps are manually performed by a user. For example, in the automated embodiments, the enforcement agent electronically records the interest in a database of the system.

Continuing with reference to step 104, the method 100 then enables the enforcement agent to provide instructions to the one or more processors to create cryptographically signed covenants and digital certificates that authenticate ownership, monitor future transactions of the property, prevent transfer of the title, and authorize transfer of the title, as governed by the cryptographically signed covenants and digital certificates.

The recorded protective covenant states that any subsequent Certificates of Compliance must be signed with the enforcement agent's cryptographic signature, which is generated using its private key through usage of a public-private key cryptography. Public-key cryptography uses a pair of mathematically related cryptographic keys, referred to as the “private key” (or “secret key”) and the “public key.” The private key is intended to be associated uniquely with one user and kept secret. The public key may be freely distributed and known to anyone.

Public-key cryptography, according to the present invention, can be used to provide confidentiality, verification, authenticity, and non-repudiation. The public-key encryption may be used to send information confidentially. For example, a sender may encrypt a message with the recipient's public key, which can only be decrypted by the recipient's paired private key.

Another application of the public-key cryptography according to the present invention is verification and authentication using digital certificates and digital signatures. Herein, the term “digital certificates” refer to a signed electronic document that notarizes and binds the connection between a public key and its legitimate owner to prove the owner's identity. Its purpose is to prevent unauthorized impersonation and provide confidence in the public keys. The term “digital signature” refers to an electronic identification of a person or thing created by using a public-key algorithm, intended to verify to a recipient the integrity of the data and the identity of the sender of the data.

Further application of the public-key cryptography according to the present invention is non-repudiation that uses digital signature to ensure that one party cannot successfully dispute authorship of a document or communication. Namely, the recipient of a communication or data has assurance that the sender in fact sent the communication or data even though the sender later may want to deny ever having sent the communication or data.

According to the present invention, users, such as the enforcement agent, can generate the digital certificate themselves. However, in some embodiments, a public-key infrastructure (PKI) using a certificate authority (CA) may be employed to issue the digital certificate. The PKI is a security architecture that increases the level of security and confidence for exchanging information electronically over a network. PKIs can be used to authenticate the sender or recipient of electronic information and/or authenticate that the content of an electronic document or message has not been deliberately altered or otherwise modified.

Generally known, a CA is a trusted individual or organization (public or private) that issues, manages and revokes digital certificates, validating that public keys are not compromised and that they belong to the correct owners. The CA may generate the public/private key pair in the digital certificate or sign the public key of a requester (after the CA verifies the identity of the requester). The CA verifies the credentials provided by the certificate requester and, upon confirming the requester's identity, digitally signs the digital certificate with the CA's private key.

Applied Cryptography, Second Edition: Protocols, Algorithms, and Source Code in C, by Bruce Schneier, published by John Wiley & Sons, Inc. in 1996, and ICSA Guide to Cryptography, by Randall K. Nichols, published by McGraw-Hill in 1999, which are incorporated by reference herein, provide additional information on the use and implementation of public-key cryptography, digital signatures and digital certificates.

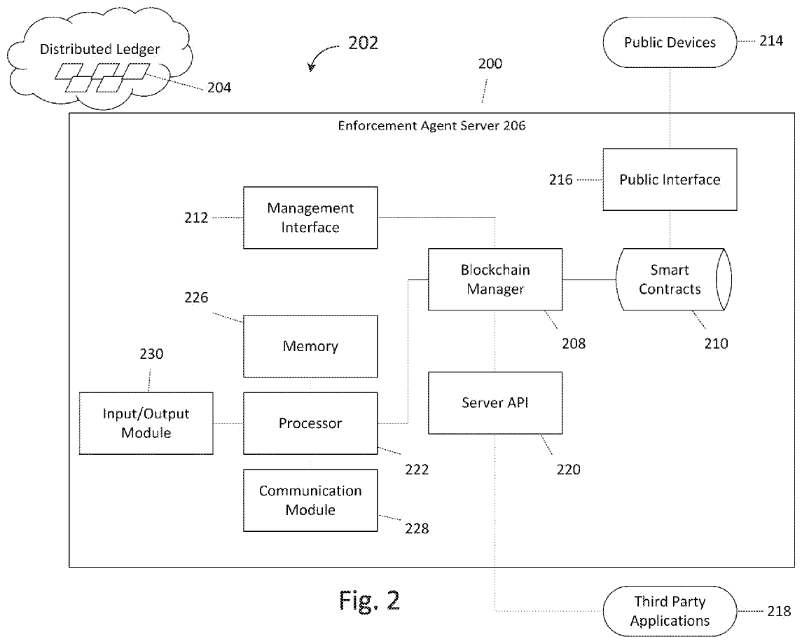

In embodiments consistent with the present invention in FIG. 2, the system 200 can include one or more input devices. The input device may be any device capable of receiving information and converting it to digital information for use by the system. The input device may be, for example, a keyboard or keypad, card reader, USB device, fingerprint or other biometric reader, camera, scanner, CD/DVD reader, handset or handheld device, personal digital assistant (PDA), wireless interface, personal computer, and/or Internet connection. The input device may be used, for example, to read digital certificate information from a smart card, magnetic strip card, or printed document. Input device may also be used, for example, to receive user identification information such as PINs, passwords, fingerprints, retinal patterns, or other biometric information. One or more connections may be provided from the input device to the system 200 through which digital data may be passed, such as a bus or a wireless connection, among others.

Thus, digital certificates and digital certificate information may be input into the system 200 in any of a number of ways known to those skilled in the art. For example, digital certificates may be stored on a physical medium, such as paper, card, or chip, and the digital certificate information stored on the physical medium may be input into system 200 by, for example, reading the information from the physical medium by using an input device, such as a scanner, card reader, or other input device. The input device may be separate from system 200 and capable of providing data electronically to system 200, either via physical connection or wirelessly. In certain embodiments, digital certificates and digital certificate information may be input into the system 200 from, for example, another device or computer across the Internet or other network connection. In other embodiments, digital certificate information is entered into system 200 by, for example, using a keyboard, mouse, user interface, or other conventional input device.

In certain embodiments, all digital certificate information is received or available locally and all authentication operations may be performed at system 200 without needing Internet or network connections.

The digital certificates may include digital certification information, such as the name of the certificate owner, a public key associated with the certificate owner, dates of validity of the certificate, the name of the CA that issued the digital certificate, the actions for which the keys may be used, and the method the CA used to sign the digital certificate (e.g., RSA).

In step 104, a digital protective covenant is generated such that the digital protective covenant verifies the receipt of the digital record of the digital information, such as the contract. A digital signature is applied to the digital protective covenant. As described above, the digital signature may be any type of signature that authenticates the identity of the owner of the repository. For example, the digital signature may be based on a private/public key encryption scheme, such as RSA. In a preferred embodiment, the certificate is digitally signed using a private key, for example, of the enforcement agent.

In step 106, the new digital record or a representation of the contract and covenant is added to a repository, such as a federated blockchain repository. The blockchain is a shared, immutable ledger that facilitates the process of recording transactions and tracking assets in a network. Virtually, any intangible or tangible asset of value can be tracked and transferred on the blockchain network reducing risk and cutting costs for all involved. According to the present invention, utilizing the blockchain technology, both intangible assets, such as the contract and covenant, and tangible assets, such as the real property including land and buildings, can be tracked, validated, and transferred.

As shown in FIG. 2, computing system 200 operates as blockchain platform in which asset transaction records—known as “blocks”—are linked via cryptographic hash functions in a distributed, immutable ledger of interconnected blocks. Each block in the chain includes one or more digital asset transactions accompanied by corroboration information representing a validity of each transaction. The architecture of the computing system 200 allows for identity verification and authentication of transacted assets while preventing duplication of a cryptography-protected (“cryptographic”) digital asset registered to the platform.

The blockchain may include a growing list of records in the form of data blocks. Each block is linked to a previous block immediately before it in the blockchain by including the cryptographic hash of the previous block. Each block may include a timestamp, a cryptographic hash of a previous block, and data of the present block, which may be one or more transactions related to the intangible asset or tangible asset of the real property.

After the records have been received and registered in the blockchain in step 106, in one aspect, the system 200 may use the record to record proof of ownership or purchase of an asset, such as a transfer of the real property between one participant and the next. The transfer of the real property may be stipulated according to the terms of the protective covenant of the contract, such as a smart contract. Thus, the blockchain may operate according to terms of the smart contract to facilitate, verify, or enforce the negotiation or performance of the contract. The user, such as the enforcement agent, may program agreed terms into the smart contract and the smart contract may be automatically executed by the blockchain system to perform a transaction. The smart contract may be operational codes that are fully or partially executed without human interaction.

According to the present invention, one of the agreed upon terms of the recorded protective covenant as programmed in the smart contract may state that any subsequent certificates of compliance must be signed by the enforcement agent's cryptographic signature, which is generated using its private key in a public-private key infrastructure. To prevent an authentic cryptographic signature from being copied onto and used to fraudulently authenticate an unauthorized document, for example, that may attempt to transfer or place a lien on the property, the present system 200 employs two independent methods that can be implement according to the system 200 and the process 100 in FIGS. 1A-1B.

In the first method, the enforcement agent creates a cryptographic hash of key terms from the approved agreement and the recorded covenant using a secure hash algorithm such as SHA 1. The enforcement agent then signs the hash with its cryptographic signature using its private key.

When the signature is authenticated using the enforcement agent's public key, the hash is decrypted. To verify that the terms in the as-yet unauthenticated document are the same terms that were in the certified agreement, the selected terms of the unauthenticated agreement, and any additional terms from the recorded covenant that were used for the signed hash's inputs, are used to create a new hash. If this hash matches the decrypted signed-hash of the terms of the authenticated agreement, then the certificate is valid.

This method can be applied to paper documents using image capture and Optical Character Recognition (OCR) or other digital representations of the key terms—for example, but not limited to, QR codes—that can represent the hashes or the inputs to be hashed and subsequently compared to the decrypted signed-hash. See, for example, A Model for Embedding and Authorizing Digital Signatures in Printed Documents, by Lee, Kwon, et al in Korea Information Security Agency, ICISC (2002), which is incorporated herein by reference.

In an alternative method, the enforcement agent places cryptographically-signed copies of the transaction documents—or of their hashes or both—into a federated blockchain repository that any authorized party can examine. Cryptographically signed documents in such a storage system are extremely difficult to alter and cannot be disavowed by the party that signed them. This reduces the risk that a stolen private key poses. An authorized party can compare the document in the repository with the one in its possession to determine whether the latter document is authentic. After the records have been received and registered in step 106, the method provides a way to verify the order in which particular records were registered. One exemplary way according to the present invention to confirm the history of recordation is to include a cryptographic digest of all previously registered records in the digital certificate issued by applying a cryptographic hash function. Cryptographic digests, which incorporate older certificates, create causal, one-way relationships between the confirmations and thus can be used to verify their order without fear of erroneous behavior, because any erroneous confirmation is detectable by a verifier examining the one-way causal hash chain.

By employing a cryptographic signature that must be authenticated before it may be relied upon, the present invention prevents a subsequent third-party purchaser of an interest that was obtained from a homeowner without the enforcement agent's involvement from claiming to be a bona fide purchaser or a holder in due course. A bona fide purchaser is a party that pays valuable consideration for a property, has no notice of any outstanding claims of other parties and acts in good faith. A holder in due course is one who takes a negotiable instrument, such as check or promissory note, for value, in good faith, and without notice of any claim or defense against it or without notice that the instrument contains an unauthorized signature or has been altered. Bona fide purchasers and holders in due course can enforce their interests free from all claims and personal defenses that previous owners and interest holders might have against the parties that sold them their interests. According to the present invention, purchasers or holders can claim such protection only if they possess authenticated certificates of compliance for the transactions through which they allegedly obtained their claimed interests. This is because such a party cannot claim not to have notice of the requirement of a digitally signed certificate of compliance and because a digital signature must be authenticated before it may be relied upon. The subsequent purchaser would either lack a certificate of compliance entirely or, having attempted to authenticate the digital signature, would know that it was a forgery.

Because prospective interest holders have constructive notice of the recorded protective covenant, and because a cryptographic signature must be authenticated before it may be relied upon and cannot be forged, it is not possible for a purchaser to rely upon an inauthentic signature in good faith. In addition to protecting homeowners against forgery, by using cryptographic signatures to freeze and unfreeze titles, the present invention also protect homeowners against fraud in the inducement, undue influence, and other forms of Harm.

The protective scheme enforced by the enforcement agent is designed to protect property owners from falling victim to Harm, including that caused by inexperience or diminished financial capacity. If a party were to attempt to enforce a claimed interest obtained without the enforcement agent's involvement, such as by obtaining an order of eviction, or to transfer it to a third party, by presenting a cryptographic signature on a certificate of compliance as proof of the legitimacy of its interest, the party would be guilty of forgery. Forgery is not only grounds for recission but also a crime.

Second, even without a court's involvement, our invention makes it difficult for bad actors to sell their claimed interests to third parties. This is because the recorded protective covenant puts third parties on notice that if they purchase a property or promissory note that is protected by a covenant but not accompanied by a certificate of compliance bearing an authentic cryptographic digital signature, they cannot claim to be good faith purchasers or holders in due course. This is because it is impossible to forge a cryptographic signature and just as impossible to knowingly accept a forged signature in good faith.

Because a cryptographic signature cannot be repudiated, if the protective scheme were to fail and fraud (other than forgery or fraud in the execution) were to be discovered after a transaction was certified, then a third-party buyer or lender in possession of a certificate of compliance signed by the enforcement agent would still have an enforceable agreement. This is because, although the underlying transaction may have been fraudulent, the third party could establish that it obtained its interest in good faith and in compliance with the terms of the covenant and without notice of any underlying fraud or claim. The cryptographically signed certificate of compliance would function as an estoppel certificate, i.e., a written, signed stipulation of established facts that prevents the author from subsequently contradicting or recanting those facts. The certificate would prevent both the victim and the enforcement agent from making covenant-related claims against the third party. Thus, our system preserves the marketability of interests conveyed in compliance with the protective scheme.

In conclusion, in embodiments where the system and method provide an additional layer of security, authentication, and verification of an asset as defined by the terms of the covenant, the present invention offers property owners the advantages of the trust and “tell a friend” approaches—prevention of isolation, ability to enforce due diligence, standing to pursue remedies, fiduciary duty, availability, and personal knowledge of the owner—but without their disadvantages: loss of control, costliness, lack of accountability, personal burden, and invasion of privacy. It allows friends and relatives of homeowners—as well as small law firms and financial advisors—to offer trustee-like protection at low cost because it narrows the scope of service to real estate protection only and invokes other services, such as legal representation, only when they are needed.

To reiterate: The system and method of the present invention is not a trust because legal title is always held by the homeowner, not by a trust or trustee, and no one other than the homeowner ever has any control over the homeowner's property.

While the described system utilizes a blockchain ledger and process for recording transfers of ownership and encumbrances of assets, it should be understood that the present technology of the blockchain network can be public, private, permissioned or built by a consortium, and may utilize one or more forms of cryptography, encoding, proof of work challenges, or other concepts and technologies involved in available blockchain standards or suitable alternative databases/ledgers.

In various embodiments, the system and method contemplates included third-party information such as non-fungible tokens (NFTs) representing digital assets associated with the property, which will be described further below.

Referring back to FIGS. 1A-1B, in step 108, a prospective counterparty applies to the enforcement agent for a certificate of compliance for a transaction.

In step 110, the enforcement agent submits the transaction to the protective scheme.

In step 112, if the transaction fails to meet the requirements of the protective scheme, the enforcement agent declines to issue a certificate of compliance to allow the transaction to proceed.

In step 114, if the transaction passes, the enforcement agent creates a cryptographic hash of the key terms of the approved transaction agreement and other supporting information, including the hash of the recorded covenant or the enforcement agent's covenant signature.

In step 116, the enforcement agent signs the hash with its cryptographic signature using its private key in step 118.

In step 120, the enforcement agent issues a certificate of compliance that includes the cryptographically signed hash.

In step 122, the enforcement agent adds the certificate of compliance to the federated blockchain repository.

The homeowner and the counterparty execute the transaction agreement. In step 124, The counterparty records the transaction agreement along with the cryptographically signed certificate of compliance, and the method 100 continues to step 126 in FIG. 1B.

In step 126, the third party interested in verifying the certificate of compliance obtains it from the recorded transaction of step 134.

In step 128, the interested third party decrypts the digitally signed deal hash on the certificate of compliance using the enforcement agent's public key, in step 130, which can be found on the protective covenant and elsewhere.

In step 132, if the decryption is successful, the hash of the key terms of the transaction agreement that was approved is revealed.

In step 134, the counterparty, or any party, examines records the recorded transaction of step 124 for the deal terms which include the recorded protective covenant hash of step 104.

In step 136, the hash of the deal is received. In step 138, the third party compares the revealed hash to the hash of the terms and other inputs on the face of the recorded agreement that purports to convey to the counterparty the interest the third party seeks to acquire.

In step 140, if the decrypted hash on the certificate of compliance matches the hash of the terms and other inputs in the recorded agreement, then the transaction was certified by the enforcement agent and the counterparty possesses a legitimate interest.

In step 142, if the decrypted hash of the certificate does not match the hash of the terms and inputs in the recorded agreement then the certificate is not valid and the counterparty does not have a legitimate interest to convey.

If the counterparty is authorized to do so, in step 140, it may access the federated blockchain repository and use the enforcement agent's public key to decrypt the hashes of the pertinent documents and examine them.

FIG. 2 depicts an exemplary environment 202 of a system 200 for creating and/or maintaining a distributed ledger or blockchain registry according to the present teaching. Although FIG. 2 depicts certain entities, components, and devices, it should be appreciated that additional or alternate components are envisioned.

As illustrated in FIG. 2, the environment 202 may include a distributed ledger or blockchain registry 204. The distributed ledger or blockchain registry 204 may be maintained via a network of nodes, third-party remote servers or other computing devices, and/or an enforcement agent server 206. The nodes may have access to distributed ledger 204 and/or generate data included in the distributed ledger 204.

According to certain aspects, as described above, the input device may be an electronic device that includes a plurality of sensors, including biometric sensors. The input device may communicate with third-party remote servers, and/or the enforcement agent server 206. In some embodiments, the system can authenticate the identity of the user using a biometric authentication to provide an additional layer of security. In certain embodiments, the system can include a biometric authentication module (not shown) that includes a control and a biometric sensor. Biometric authentication can begin with the collection of a digital biometric sample (e.g., bitmap image of user's fingerprint) using the biometric sensor to confirm the user's identity.

As illustrated in FIG. 2, the enforcement agent server 206 may include a blockchain manager 208. The blockchain manager 208 may be a software program, engine, and/or a module that is executed by one or more processors interconnected with the enforcement agent server 206. In one embodiment, the blockchain manager 208 may compile a plurality of transactions into a block, update the distributed ledger 204 to include a block, route transaction data to one or more smart contracts, and/or automatically enforce one or more smart contracts associated with the real property.

According to certain aspects, an operator of the enforcement agent server 206 may interact with a management interface 212 to control aspects of the distributed ledger 204 and/or set control parameters associated with the blockchain manager 208. In one aspect, the plurality of smart contracts associated with the distributed ledger 204 and the real property may be stored in a smart contracts database 210. Although FIG. 2 depicts the smart contract database 210 as a part of the enforcement agent sever 206, the smart contract database 210 may be maintained within the distributed ledger 204.

According to certain aspects, one or more public devices 214 may access data stored at the enforcement agent server via a public interface 216, such as by using the real property identification information, such as the property address or legal description of the property, to access the data. The public interface 216 may be used, for example, to view data maintained within the distributed ledger 204 associated with the real property, to view the status of one or more smart contracts associated with the real property and/or the distributed ledger 204, compile statistics regarding data maintained in the distributed ledger, and so on.

Additionally, or alternatively, one or more third-party applications 218 may interact with the distributed ledger 204 via an application program interface (API) 220 of the enforcement agent server 206. The third ⁻party applications 218 may be associated with one or more entities associated with real property. For example, the third-party applications 218 may include an application to generate various transactions identified by the real property, such as update title status, update ownership information, update lien and lienholder information, and so on. It should be appreciated that although FIG. 2 depicts the third-party applications 218 as separate from the enforcement agent sever 206, in some embodiments a portion of the third-party applications 218 may be stored locally at the enforcement agent server 206.

The exemplary environment 202 may include additional, fewer, or alternate equipment or components, including those discussed elsewhere herein. Further, in some embodiments, the actions described as being performed by the enforcement agent server 206 may additionally or alternatively be performed at one or more of the input devices, or third-party remote servers or computing devices.

As illustrated in FIG. 2, in accordance with some example embodiments, system 200 may include various means, such as one or more processors 222, memories 226, communications modules 228, and/or input/output modules 230. As referred to herein, the term “module” includes hardware, software and/or firmware configured to perform one or more particular functions. In this regard, system 200 as described herein may be embodied as, for example, circuitry, hardware elements (e.g., a suitably programmed processor, combinational logic circuit, and/or the like), a computer program product comprising computer-readable program instructions stored on a non-transitory computer-readable medium (e.g., memory 226) that is executable by a suitably configured processing device (e.g., processor 222), or some combination thereof.

Processor 222 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. In an example embodiment, processor 222 is configured to execute instructions stored in memory 226 or otherwise accessible to processor 222. These instructions, when executed by processor 222, may cause system 200 to perform one or more of the functionalities of system 200 as described herein.

Memory 226 may comprise a single memory or may comprise a plurality of memory components. The plurality of memory components may be embodied on a single computing device or distributed across a plurality of computing devices. In various embodiments, memory 226 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. In some embodiments, memory 226 may comprise one or more databases. Memory 226 may be configured to store information, data, applications, instructions, or the like for enabling system 200 to carry out various functions in accordance with example embodiments of the present invention.

Communications module 228 may be embodied as any device or means embodied in circuitry, hardware, a computer program product comprising computer readable program instructions stored on a computer readable medium (e.g., memory 226) and executed by a processing device (e.g., processor 222), or a combination thereof that is configured to receive and/or transmit data from/to another device. In this regard, communications module 228 may be in communication with processor 222, such as via a bus. Communications module 228 may include, for example, an antenna, a transmitter, a receiver, a transceiver, network interface card and/or supporting hardware and/or firmware/software for enabling communications with another computing device.

Input/output module 230 may be in communication with processor 222 to receive an indication of a user input and/or to provide an audible, visual, mechanical, or other output to a user. As such, input/output module 230 may include support, for example, for a keyboard, a mouse, a joystick, a display, a touch screen display, a microphone, a speaker, a RFID reader, barcode reader, biometric scanner, and/or other input/output mechanisms.

In some embodiments, non-transitory computer readable storage media can be configured to store firmware, one or more application programs, and/or other software, which include instructions and other computer-readable program code portions that can be executed to control each processor (e.g., processor 222, engine and/or a module of the engine) of the system 200 to implement various operations. As such, a series of computer-readable program code portions are embodied in one or more computer program products and can be used, with a computing device, server, and/or other programmable apparatus, to produce machine-implemented processes.

In various embodiments, the system and method contemplates the present teaching in use with non-fungible tokens (NFTs). Some aspects of this invention are directed to digital asset ownership. The digital asset can be recorded as a non-fungible token (NFT) in a blockchain. The present invention adds protective schemes to the blockchain which prevent future transfer of the NFT when the protective scheme's requirements have not been met.

In various embodiments, the system and method contemplates extending third party information systems to include notice of the protective covenant. Sometimes, an unscrupulous party will check the land records when attempting to steal a person's home title or deed. According to an example of the present invention, the shared data from the protective covenant blockchain may be available to third parties, such as Zillow®. When a party conducts a search for the property on the land registry records or a property listing site, a digital representation of the real property, as the NFT, linked with the terms of the covenant may be displayed to the person searching the records to put them on notice of the restriction and/or requirements for an authenticated transfer of the real property.

Aspects of this disclosure may be implemented, in some embodiments, through a computer-executable program of instructions, such as program modules, generally referred to as software applications or application programs executed by any of a controller or the controller variations described herein. Software may include, in non-limiting examples, routines, programs, objects, components, and data structures that perform particular tasks or implement particular data types. The software may form an interface to allow a computer to react according to a source of input. The software may also cooperate with other code segments to initiate a variety of tasks in response to data received in conjunction with the source of the received data. The software may be stored on any of a variety of memory media, such as CD-ROM, magnetic disk, bubble memory, and semiconductor memory (e.g., various types of RAM or ROM).

Moreover, aspects of the present disclosure may be practiced with a variety of computer-system and computer-network configurations, including multiprocessor systems, microprocessor-based or programmable-consumer electronics, minicomputers, mainframe computers, and the like. In addition, aspects of the present disclosure may be practiced in distributed-computing environments where tasks are performed by resident and remote-processing devices that are linked through a communications network. In a distributed-computing environment, program modules may be located in both local and remote computer-storage media including memory storage devices. Aspects of the present disclosure may therefore be implemented in connection with various hardware, software or a combination thereof, in a computer system or other processing system.

Any of the methods described herein may include machine readable instructions for execution by: (a) a processor, (b) a controller, and/or (c) any other suitable processing device. Any algorithm, software, control logic, protocol or method disclosed herein may be embodied as software stored on a tangible medium such as, for example, a flash memory, a CD-ROM, a floppy disk, a hard drive, a digital versatile disk (DVD), or other memory devices. The entire algorithm, control logic, protocol, or method, and/or parts thereof, may alternatively be executed by a device other than a controller and/or embodied in firmware or dedicated hardware in an available manner (e.g., implemented by an application specific integrated circuit (ASIC), a programmable logic device (PLD), a field programmable logic device (FPLD), discrete logic, etc.). Further, although specific algorithms are described with reference to flowcharts depicted herein, many other methods for implementing the example machine-readable instructions may alternatively be used.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and sub-combinations of the preceding elements and features.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments described herein can be embodied within a form that does not provide all of the features and benefits set forth herein, as some features can be used or practiced separately from others. All changes that come within the meaning and range of equivalency of the claims are to be embraced within their scope.

What is claimed is:

1. A computer-implemented method for verifying consent to modify the title to a particular property, the method comprising:
receiving, at a computing device running an automated agent, a request from a property owner to prepare a contract record for storing contract data regarding terms of the contract in a blockchain or a database;
dynamically monitoring, by the automated agent, received transaction activity related to a real property owned by the property owner to verify and authenticate a real property transfer-related event according to terms of the contract, wherein terms and conditions of the contract includes a protective scheme;
generating, by the automated agent, a covenant for recordation against the title of the real property based on the contract, wherein the covenant includes a public key and a protective scheme;
creating a digital signature by signing the covenant with a cryptographic signature private key of the automated agent; and
storing, by the automated agent, the data of the contract record and the covenant record in a repository in a blockchain distributed ledger having a plurality of transactions stored in the blockchain formed from blocks of records containing transactions, or stored in the database.

2. The method of claim 1, wherein the protective scheme is designed to limit future title transactions of the real property; and
wherein the covenant specifies that a future certificate of compliance must be cryptographically signed by a private key of the automated agent.

3. The method of claim 2, further comprising receiving, by the automated agent, a request from a prospective transferee of a proposed agreement to conduct a property-related transaction regarding the real property; and
extracting, by the automated agent, the terms and conditions of the protective scheme from a data block previously stored on the blockchain distributed ledger or the database.

4. The method of claim 3, further comprising determining, by the automated agent, if the property-related transaction request satisfies the extracted terms and conditions of the protective scheme;
in response to successful satisfaction of the extracted terms and conditions of the protective scheme, approving, by the automated agent, the proposed agreement;
upon approval of the proposed agreement, designating the prospective transferee as a transferee having a property interest in the real property; and
generating a first hash of the approved proposed agreement and related information; and, including, into the first hash, a second hash of the recorded covenant or the digital signature of the covenant.

5. The method of claim 4, further comprising signing the first hash with the digital signature using the private key of the automated agent.

6. The method of claim 5, further comprising generating, by the automated agent server, a digital certificate of compliance that includes the cryptographically signed first hash; and
sending the digital certificate of compliance including the cryptographically signed first hash to a requester from which the property-related transaction request was received.

7. The method of claim 5, further comprising generating, by the automated agent server, a digital certificate of compliance that includes the cryptographically signed first hash; and
storing, within a data block of the repository of the blockchain or the database, the digital certificate of compliance including the cryptographically signed first hash.

8. The method of claim 6, further comprising storing a recordation of the property interest of the transferee and the terms of the transaction agreement agreed to by the transferee along with the cryptographically signed certificate of compliance within another data block of the blockchain or the database.

9. The method of claim 8, wherein the property interest of the transferee is transferable to a third party, and further comprising receiving a notification, at the automated agent, that the transferee has made an offer to sell the property interest to the third party, and
in response to the notification of the offer to sell, receiving, at the automated agent, a request from the third party to decrypt the digitally signed first hash from the certificate of compliance using the public key of the automated agent, to create a third hash.

10. The method of claim 9, further comprising generating, by the automated agent, a fourth hash derived from the second hash and transaction detail data of the recordation of the property interest of the transferee and the terms of the transaction agreement agreed to by the transferee along with the cryptographically signed certificate of compliance;
wherein a successful match between the third hash and the fourth hash, verifies authenticity of the contract record and the covenant record in the blockchain or recorded document using the public key to confirm consent of the real property transfer, wherein the public key is generated by a certificate authority or a user of the computing device;
in response to the successful match of the third hash and the fourth hash, sending, by the automated agent, the first hash to the third party; and
providing confirmation to the third party that the property transaction was certified by the automated agent and that the transferee possesses a legitimate property interest.

11. The method of claim 9, further comprising generating, by the automated agent, a fourth hash derived from the second hash and transaction detail data of the recordation of the property interest of the transferee and the terms of the transaction agreement agreed to by the transferee along with the cryptographically signed certificate of compliance;
wherein, in response to an unsuccessful decryption of the signature on the certificate of compliance or when the third hash does not match the fourth hash, sending, by the automated agent, a rejection notification to the third party that the certificate of compliance is not valid; and
informing the third party that the property interest is not valid.

12. The method of claim 1, wherein the automated agent is operable through use of the computing device with some human intervention or autonomously without human intervention.

13. The method of claim 2, wherein the contract is a smart contract that includes computer-readable instructions for verifying, authenticating and approving the property transfer-related event according to the terms and conditions of the protective scheme.

14. The method of claim 10, further comprising generating, by a server connected to the computing device, a cryptographic digital asset associated with the real property, wherein the cryptographic digital asset comprises a non-fungible token (NFT);
linking the digital asset and NFT with the contract record and the covenant record for recordation in a new block in the blockchain distributed ledger; and
in response to the successful decryption, sending access information to the third party for accessing the digital asset and the NFT on the blockchain.

15. A non-transitory computer readable storage medium at a computing device running an automated agent and having connectivity to a network, wherein the non-transitory computer readable storage media are encoded with instructions that, when executed by a processor, cause the processor to:
receive, at the automated agent, a request from a property owner to prepare a contract record for storing contract data regarding terms of the contract in a blockchain;
dynamically monitor received transaction activity related to a real property owned by the property owner to verify and authenticate a real property transfer-related event according to terms of the contract, wherein terms and conditions of the contract includes a protective scheme;
generate, by the automated agent, a covenant record for recording covenant data regarding recordation of a covenant against the title of the real property based on the contract, wherein the covenant includes a public key and a protective scheme;
create a digital signature by signing the covenant with a cryptographic signature private key of the automated agent; and
store, by the automated agent, the data of the contract record and the covenant record in a repository in a blockchain distributed ledger having a plurality of transactions stored in the blockchain formed from blocks of records containing transactions.

16. The non-transitory computer readable storage media of claim 15, wherein the protective scheme is designed to limit future title transactions of the real property; and
wherein the covenant specifies that a future certificate of compliance must be cryptographically signed by a private key of the automated agent.

17. The non-transitory computer readable storage media of claim 16, further comprising instructions operable to:
receive, by the automated agent, a request from a prospective transferee for a certificate of compliance and a proposed agreement to conduct a property-related transaction regarding the real property; and
extract, by the automated agent, the terms and conditions of the protective scheme from a data block previously stored on the blockchain distributed ledger.

18. The non-transitory computer readable storage media of claim 17, further comprising instructions operable to:
determine, by the automated agent, if the property-related transaction request satisfies the extracted terms and conditions of the protective scheme;
in response to successful satisfaction of the extracted terms and conditions of the protective scheme, approve, by the automated agent, the proposed agreement;
upon approval of the proposed agreement, designate the prospective transferee as a transferee having a property interest in the real property; and
generating a first hash of the approved proposed agreement and related information; and, including, into the first hash, a hash of the recorded covenant or the digital signature of the covenant.

19. The non-transitory computer readable storage media of claim 18, further comprising instructions operable to:
generate, by the automated agent server, a digital certificate of compliance that includes the cryptographically signed first hash; and
store, within a data block of the repository of the blockchain, the digital certificate of compliance including the cryptographically signed transaction hash.

20. The non-transitory computer readable storage media of claim 19, further comprising instructions operable to:
store a recordation of the property interest of the transferee and the terms of the transaction agreement agreed to by the transferee along with the cryptographically signed certificate of compliance within another data block of the blockchain, wherein the property interest of the transferee is transferable to a third party;
receive a notification, at the automated agent, that the transferee has made an offer to sell the property interest to the third party, and
in response to the notification of the offer to sell, receive, at the automated agent, a request from the third party to decrypt the digitally signed deal hash, to create a third hash, on the certificate of compliance using the public key of the automated agent;
generate, by the automated agent, a fourth hash derived from the second hash and transaction detail data of the recordation of the property interest of the transferee and the terms of the transaction agreement agreed to by the transferee along with the cryptographically signed certificate of compliance;
wherein a successful match between the third hash and the fourth hash verifies authenticity of the contract record and the covenant record in the blockchain using the cryptographically certificate to confirm consent of the real property transfer;
in response to the successful match of the third hash and the fourth hash, send, by the automated agent, the first hash to the third party; and
provide confirmation to the third party that the property transaction was certified by the automated agent and that the transferee possesses a legitimate property interest.

21. A computer-implemented method comprising:
generating, by a server connected to a computing device, a digital asset comprising a non-fungible token (NFT) for storing in a blockchain system;
receiving, into the server, data corresponding to one or more covenants that defines one or more prerequisite terms to effectuate transfer of the digital asset including the NFT; and
processing, by the server, the data of the one or more covenants by creating a record and linking the record to the digital asset and the NFT in the blockchain.

22. The method of claim 21, further comprising: implementing, by the server, the one or more covenants as a smart contract that includes computer-readable instructions for verifying, authenticating and approving a transfer-related event according to the terms of the one or more covenants.

23. The method of claim 21, further comprising: implementing, by the server, the one or more covenants by performing one or more transactions according to the one or more prerequisite terms before transferring the digital asset including the NFT across the blockchain.

24. The method of claim 23, further comprising linking, by the server, the digital asset in the blockchain to one or more files associated with a tangible asset to control transfer of the tangible asset according to the one or more covenants and recordation of a record of the transfer of the tangible asset in the blockchain.

25. The method of claim 24, wherein the tangible asset is associated with a real property.
